(19) United States
(12) Patent Application Publication
(10) Pub. No.: US 2013/0034640 A1
(43) Pub. Date: Feb. 7, 2013

(54) CHAR MARKER RINGS AND ASSEMBLIES

(71) Applicants: William Douglas Medley, Clyde, OH (US); William D. Miller, Sandusky, OH (US)

(72) Inventors: William Douglas Medley, Clyde, OH (US); William D. Miller, Sandusky, OH (US)

(73) Assignee: JOHN BEAN TECHNOLOGIES CORPORATION, Chicago, IL (US)

(21) Appl. No.: 13/204,550

(22) Filed: Aug. 5, 2011

(51) Int. Cl. A22C 17/10; A23P 1/10

(52) U.S. Cl. 426/383; 99/483

(57) ABSTRACT

Char marker rings generally include a ring body having first and second sides, an inner hole extending through the body from the first side to the second side, and an outer perimeter marking surface, and at least a first shield extending outwardly from either of the first and second sides, wherein the first shield surrounds at least a portion of the inner hole. Ring assemblies and methods of using char marker ring assemblies are also provided.

### BACKGROUND

When precooking patties (for example, beef, chicken, or soy patties) and other food products at a high production rate for fast food or for frozen dinners, it is often desirable to simulate the effect of broiling food products on a grill, which is commonly called “char marking” in the food processing industry. Char marking improves the eye appeal of the product by branding spaced parallel stripes, giving the appearance that the product was broiled over charcoal on spaced grill bars.

In a previously designed char marking assembly described in U.S. Pat. No. 4,026,201, issued to Fetzer, a plurality of hot parallel rings roll on a mandrel over products carried by a conveyor belt. Each ring is allowed to independently follow its own rolling path on the mandrel, thereby compensating for size irregularities in the individual products. This assembly, however, has been found to be limited in performance as a result of limitations in heat absorption on the outer perimeter marking surface of its individual rings. Limited heat transfer to the marking surface limits the marking speed of the char marker, which in turn means that the overall speed of a food processing line may be limited by the speed of the char marker.

Therefore, there exists a need for improved heat transfer to the marking surface of the rings to improve char marking results and potentially increase the throughput of a char marking system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a char marker ring is provided. The char marker ring generally includes a ring body having first and second sides, an inner hole extending through the body from the first side to the second side, and an outer perimeter marking surface. The char marker ring further includes at least a first shield extending outwardly from either of the first and second sides, wherein the first shield surrounds at least a portion of the inner hole.

In accordance with another embodiment of the present disclosure, a char marker ring assembly is provided. The char marker ring assembly generally includes a mandrel assembly and a plurality of char marker rings received on the mandrel assembly, each of the char marker rings comprising a ring body having first and second sides, an inner hole extending though the body from the first side to the second side, and an outer perimeter marking surface. At least a first shield extends outwardly from either of the first and second sides, wherein the first shield surrounds at least a portion of the inner hole.

In accordance with one embodiment of the present disclosure, a method of using a char marker ring assembly is provided. The method generally includes obtaining a char marker ring assembly comprising a plurality of char marker rings received on a mandrel assembly, each of the char marker rings having an outer perimeter marking surface. The method further includes rotating the plurality of char marker rings on the mandrel assembly, heating the outer perimeter marking surfaces of each of the plurality of char marker rings with a plurality of flames, and shielding at least a portion of the direct flame heat from the mandrel assembly.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a front plan view of a char marking assembly in use with a conveyor belt in accordance with one embodiment of the present disclosure;

FIG. 2 is a partial top plan view of the char marking assembly of FIG. 1;

FIGS. 3 and 4 are front and back perspective views of an individual char marking ring from the char marking assembly of FIG. 1;

FIG. 5 is a close-up, cross-sectional side view showing the interface between adjacent char marking rings as seen in FIG. 1;

FIG. 6 is an exploded view of the individual char marking ring shown in FIGS. 3 and 4;

FIGS. 7 and 8 are side views of individual char marking rings in accordance with other embodiments of the present disclosure;

FIG. 9 is a close-up, cross-sectional side view of an individual char marking ring in accordance with yet another embodiment of the present disclosure; and

FIG. 10 is a partial top plan view of a prior art char marking assembly.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Accordingly, the following descriptions and illustrations herein should be considered illustrative in nature, and thus, not limiting the scope of the disclosed subject matter.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

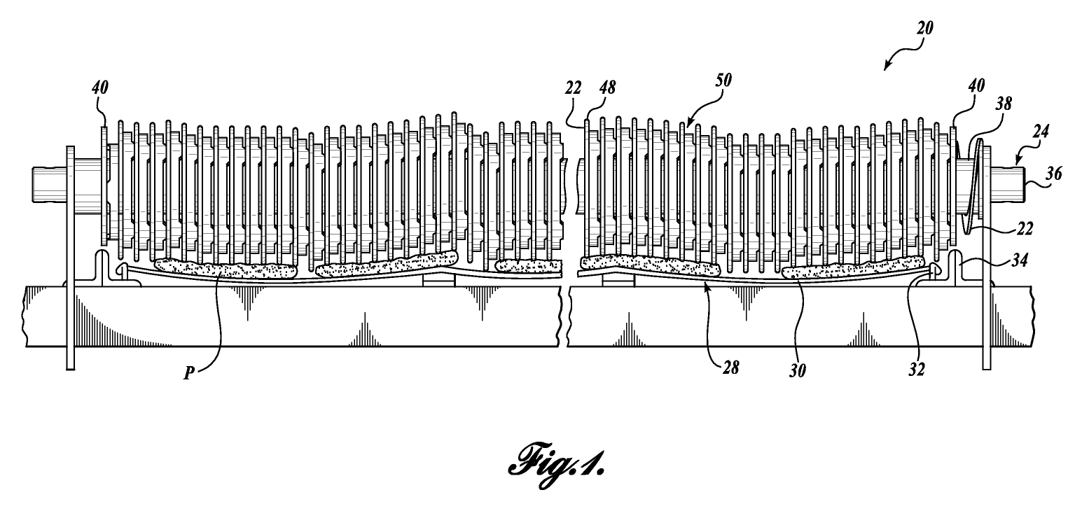

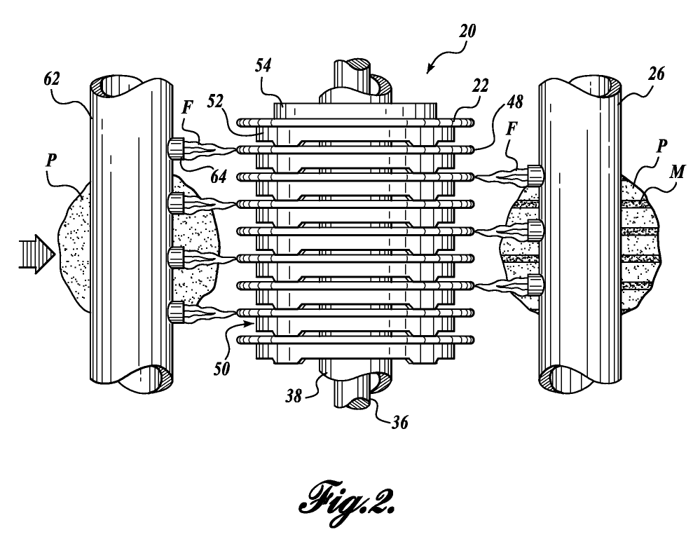

Embodiments of the present disclosure are generally directed to char marker rings, char marker ring assemblies that include a plurality of char marker rings, and methods of using char marker ring assemblies to brand products. Referring to FIGS. 1 and 2, a char marker ring assembly 20 in accordance with one embodiment of the present disclosure includes a plurality of char marker rings 22 that are assembled on a supporting mandrel assembly 24. The char marker assembly 20 may be heated by a heating system 26 (see, for example, FIG. 2) so that it can brand products P.

Char marking in accordance with embodiments described herein generally involves the production of a large number of food products that are carried by a conveyor system 28. In that regard, products P are generally conveyed by a conveyor belt 30 in a plurality of rows across the width of the conveyor belt 30, as can be seen in FIG. 1. The conveyor belt 30 is mounted between guides 32 carried on a frame 34.

Although shown and described as being used for char marking food products, such as patties (for example, beef, chicken, or soy patties), it should be appreciated that embodiments of the present disclosure may be useful in other food processing or non-food processing applications. For example, this assembly may also be used to create branding marks on leather, paper, canvas, fabric, and wood products.

When a char marking assembly 20 is in operation in accordance with embodiments of the present disclosure, char marker rings 22 are heated to a branding temperature, for example, in the range of about 1500-2000° F., by a heating system 26 (see FIG. 2) to heat the outer perimeter marking surfaces 48 of the char marker rings 22, wherein the heating system 26 is described in greater detail below. When the marker rings 22 are sufficiently heated, the products P (traveling from left to right, as seen in FIG. 2) pass beneath the marker rings 22, and the marker rings 22 brand a char marking M into the products P. The products P exit on the right with clear and consistent parallel-spaced char markings M.

The mandrel assembly 24 receives and supports the plurality of char marker rings 22. In the illustrated embodiment, the mandrel assembly 24 includes a supporting shaft 36 and a ring support tube 38. The char marker rings 22 are received on the ring support tube 38, which is in turn received on the supporting shaft 36. Two end rings 40 are rigidly attached to the ring support tube 38 and maintain the plurality of char marker rings 22 on the tube 38. For example, the end rings 40 may be welded or otherwise rigidly attached to the mandrel assembly 24. A biasing member 66, such as a capture spring, may be used to maintain the plurality of rings 22 in compression to maintain consistent spacing between adjacent rings 22.

The mandrel assembly 24 is configured to rotate the plurality of char marker rings 22. Typically, the char marker ring assembly 20 is configured to rotate around the supporting shaft 36 and ring support tube 38 at substantially the same speed as the conveyor belt 30, with the plurality of individual char marker rings 22 ideally rotating together. In the illustrated embodiment of the present disclosure, the char marker ring assembly 20 is not a driven assembly, and the plurality of rings 22 rotate at substantially the same speed as the conveyor belt 30 as a result of friction contact with the products P on the conveyor belt 30 and with adjacent rings 22. In another embodiment, the char marker ring assembly 20 may be a driven assembly. The drive assembly may be run at substantially the same speed as the conveyor belt 30 and may help with ring 22 slip relative to the conveyor belt 30.

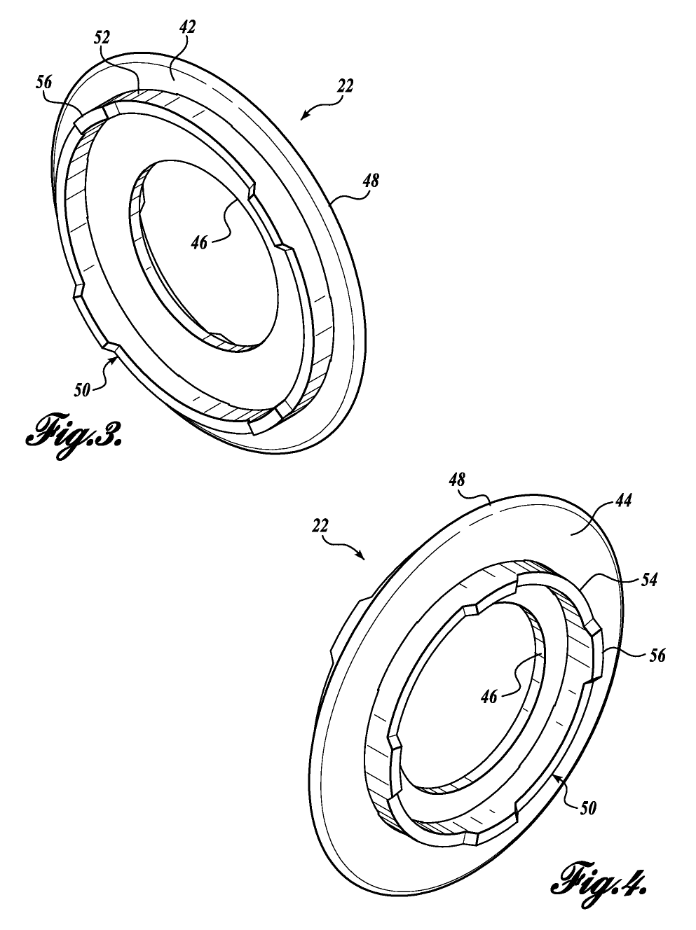

Now referring to FIGS. 3-6, the char marker rings 22 will be described in greater detail. As seen in FIGS. 3 and 4, the char marker rings 22 are individual rings having a ring body with first and second sides 42 and 44, an inner hole 46, and an outer perimeter marking surface 48 for marking products. The inner hole 46 is sized and shaped to be received on the mandrel assembly 24 such that each ring 22 is configured to rotate with the mandrel assembly 24. In the illustrated embodiment, the inner hole 46 is concentric with the outer perimeter marking surface 48; however, it should be appreciated that the inner hole 46 need not be centered.

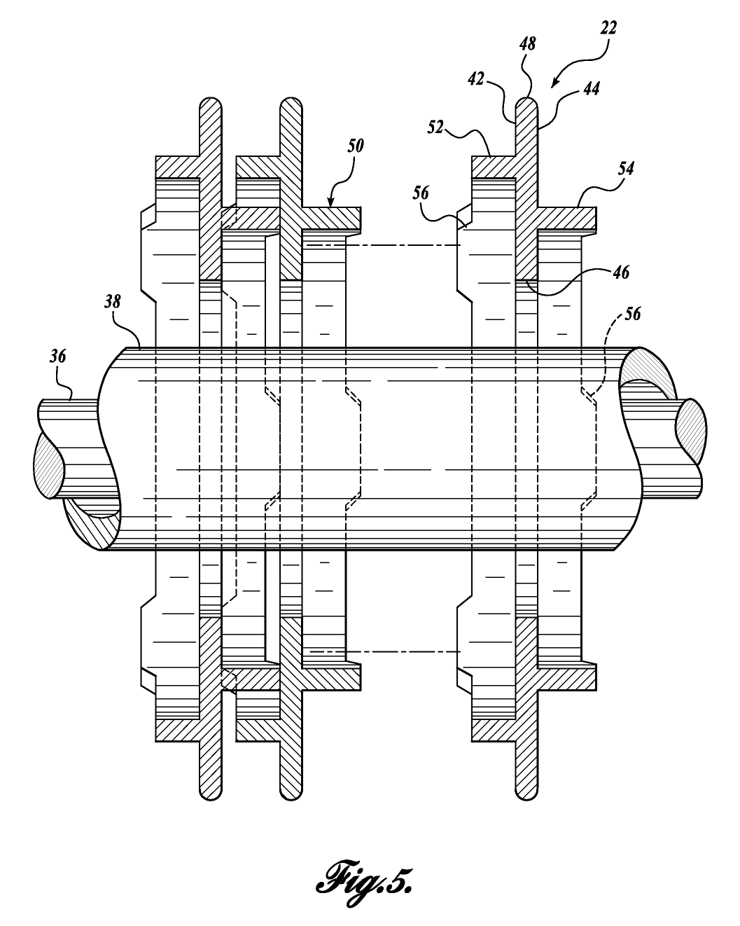

Although the mandrel assembly 24 is configured to rotate with the char marker rings 22 together and at substantially the same speed as the conveyor belt 28, the rings are designed to independently move up and down, within certain limits, relative to the mandrel assembly 24. With such up and down movability, the char marker assembly 20 can accommodate irregularly shaped products P, as can be seen in FIG. 1. In the illustrated embodiment of FIG. 5, the diameter of the inner hole 46 is sized to be larger than the diameter of the support tube 38. This sizing allows for independent up and down movement of the individual char marker rings 22 relative to the mandrel assembly 24. The up and down movement of the individual char marker rings 22 relative to the mandrel assembly 24 is also described in U.S. Pat. No. 4,026,201, issued to Fetzer, the disclosure of which is hereby expressly incorporated by reference.

The diameter of the ring 22 itself may be sized to be suitable for any specific marking application. In that regard, both large and small diameter rings 22 are within the scope of the present disclosure. For example, in certain applications, larger diameter rings create more distance between the heating system 26 and the mandrel assembly 24. Therefore, larger diameter rings may further aid in reducing the heat transfer to the supporting shaft 36 and other components of the mandrel assembly 24 by increasing the distance between the heating system 26 (for example, flame F in FIG. 2) and the mandrel assembly 24.

The individual rings 22 are designed such that, when assembled together, the outer perimeter marking surfaces 48 are spaced from one another to achieve stripes on the food products that simulate branding from parallel grill bars on a conventional broiling grill. This spacing is achieved by a shielding assembly 50 having a certain shield height. In the illustrated embodiment, the shielding assembly 50 includes a first shield 52 extending outwardly from the first side 42 of the ring 22 and a second shield 54 extending outwardly from the second side 44 of the ring 22. The height of the shields 52 and 54 extending from the planar surfaces of the first and second sides 42 and 44 is determined by the desired spacing to be achieved between adjacent outer perimeter marking surfaces 48. For example, the shield height may be in the range of about ⅛ inch to about 1 inch. The thickness of the ring 22, which defines the thickness of the outer perimeter marking surface 48, may be in the range of about ⅛ inch to about ½ inch. However, it should be appreciated that other shield heights and ring thicknesses are also within the scope of the present disclosure.

While the first and second shields 52 and 54 have a shield height to create proper spacing between adjacent outer perimeter marking surface 48, the shielding also improves heat transfer from the heating system 26 to the marking surfaces 48 as a result of increased ring mass and ring surface area. Further, the shielding also creates a labyrinth for the heat path and prevents a direct heat source (such as a direct flame) from impinging the surface of the mandrel assembly 24, as described in greater detail below.

The shields 52 and 54 surround at least a portion of inner hole 46. In the illustrated embodiment of FIGS. 3 and 4, the first and second shields 52 and 54 extend outwardly as substantially continuous shields that are substantially perpendicular to the planar surfaces of the first and second sides 42 and 44 of the ring 22. In that regard, the first and second shields 52 and 54 form substantially continuous or closed lips around the inner hole 46 of the ring 22 to shield the supporting shaft 36 and other components of the mandrel assembly 24 from the heating system 26, for example, a high temperature flame F (see FIG. 2).

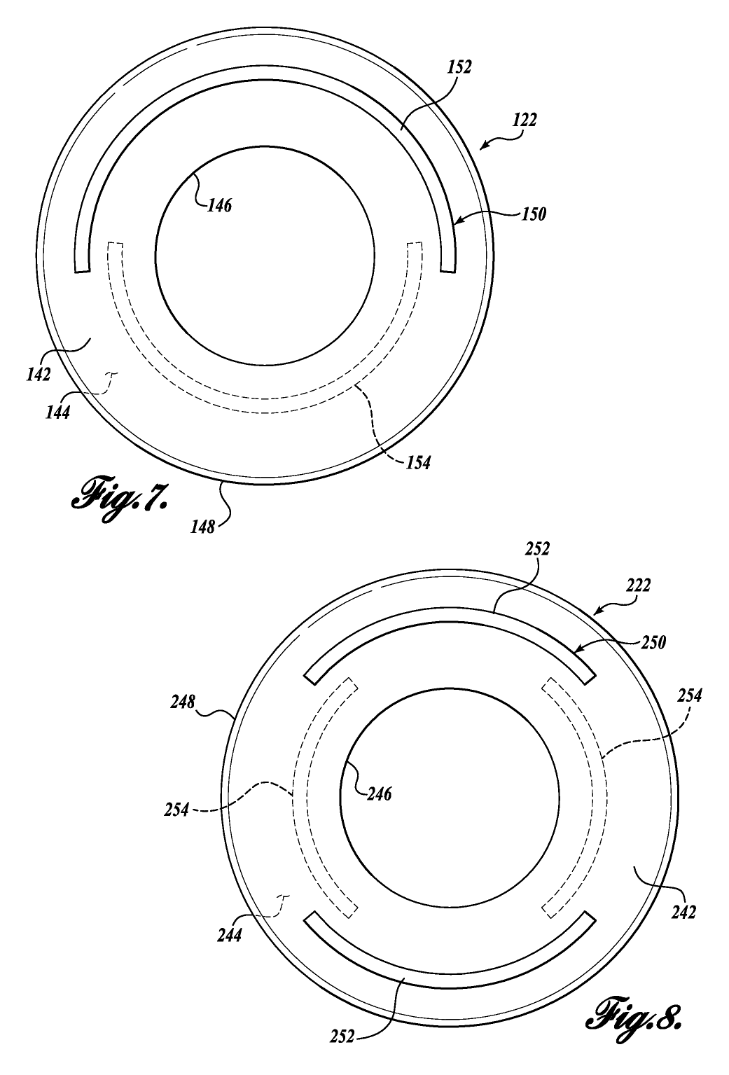

In the illustrated embodiment, the first and second shields 52 and 54, which have a continuous circular shape, form cylindrical shaped shields. In a circular shape, the shields 52 and 54 may be concentric with either the inner hole 46 or the outer perimeter marking surface 48, or both. However, it should be appreciated that other shield shapes, such as rectangular, hexagonal, octagonal, and other polygonal shapes, are also within the scope of the present disclosure. Moreover, concentricity is not required. Further, it should be appreciated that non-continuous shields are also within the scope of the present disclosure, so long as the mandrel assembly 24 is at least partially shielded from direct impingement of the heating system 26 (for example, see alternate embodiments in FIGS. 7 and 8 described in greater detail below).

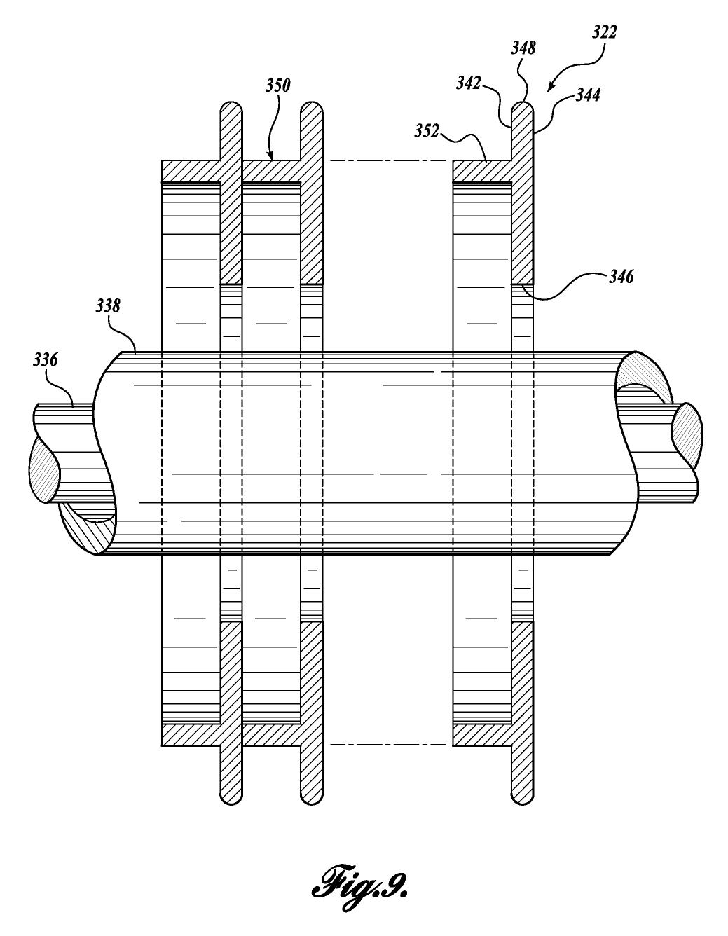

As can be seen in FIG. 5, the first shield 52 has a larger diameter than the diameter of the second shield 54, so that the second shield 54 can nest within the first shield 52 of an adjacent char marker ring 22. When assembled together, adjacent char marker rings 22 interface with one another to provide a double or two-step shield assembly 50, which forms a labyrinth to improve heat transfer to the marking surfaces 48 and to protect the mandrel assembly 24 from heat penetration from the heating system 26. Although shown and described in the illustrated embodiment of FIGS. 3-6 as a two-step shield assembly 50, it should be appreciated that single shield assemblies are also within the scope of the present disclosure (see, for example, an alternate embodiment in FIG. 9 described in greater detail below).

The first and second shields 52 and 54 may be located at any position on the ring sides 42 and 44 between the inner hole 46 and the outer perimeter marking surface 48. It should be appreciated, however, that improved heat transfer may be achieved when the first or second shield 52 and 54, or both, are positioned near the outer perimeter marking surface 48 on the first and second sides 42 and 44. With outermost positioning, heat from the heat source 28 is stored in the capacitor shields 52 and 54 nearest the outer perimeter marking surface 48 and is retained as far as possible from the mandrel assembly 24.

In the illustrated embodiment, each of the first and second shields 52 and 54 includes a plurality of scalloped extensions 56 that interface with second and first sides 44 and 42 of adjacent rings 22. Such extensions 56 are designed to minimize the contact points between adjacent rings 22. In that regard, the inventors have found that when metal rings 22, for example, stainless steel rings, rub together, they may generate undesirable black particles that may fall onto and contaminate the products P passing under the rings 22. Although shown as trapezoidal shaped extensions 56, it should be appreciated the pins, knobs, or other suitable spacers are also within the scope of the present disclosure. Further, it should be appreciated that extensions are desirable but are not required, and each shield 52 or 54 may interface directly with the respective second or first side 44 or 42 of an adjacent ring 22 (see, for example, the illustrated embodiment of FIG. 9).

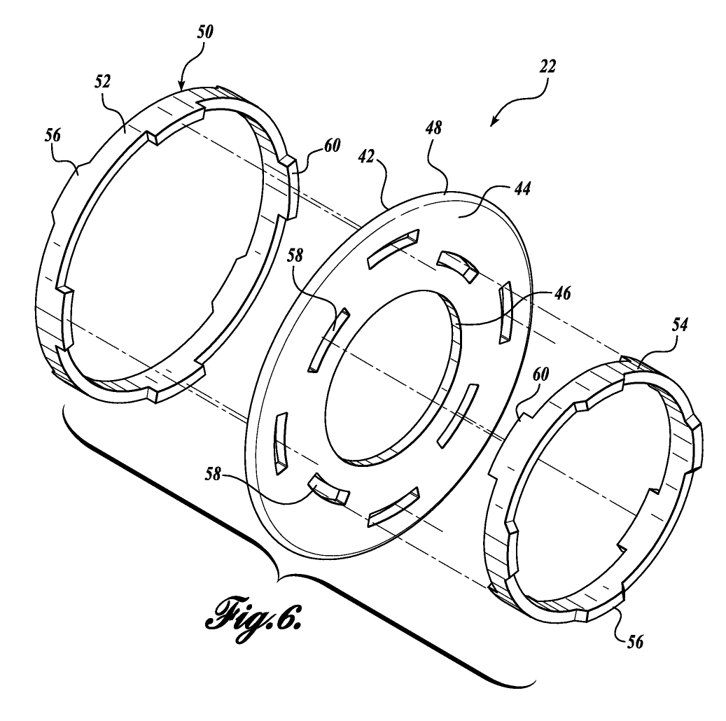

A non-limiting example of a method of making a ring 22 can be seen in FIG. 6. In that regard, shields 52 and 54 having scalloped extensions 56 can be welded to the first and second sides 42 and 44 of the ring 22. In that regard, steps 60 are fit with step-receiving holes 58 and are then welded, thereby providing structural integrity to the shield attachment. However, it should be appreciated that other manufacturing processes are within the scope of the present disclosure.

Suitable materials for the ring 22 include metal and metal alloys such as stainless steel and other suitable metals that are capable of withstanding high temperatures and other harsh factors in a food processing environment. It should also be appreciated that the ring 22 may be made from a different metal having different thermal conductivity properties than the shield assembly 50. For example, the material selection for the ring 22 may be a metal or metal alloy having thermal conductivity properties for retaining heat and having a longer life cycle at higher temperatures. In contrast, the material selection for the shield assembly 50 may be a metal or metal alloy having higher thermal conductivity relative to the metal or metal alloy material in the ring 22. This difference in thermal conductivities may enable heat loss from the outer perimeter marking surfaces 48 of the ring 22 to food products P on the conveyor belt 30 to be replenished from heat stored in the shield assembly 50. Suitable metals for use in accordance with embodiments of the present disclosure may include tungsten, carbon steel, zirconium, silver, and various alloys including one or more of these metals.

As can be seen in FIG. 2, one suitable heating system 26 for the char marking assemblies in accordance with embodiments of the present disclosure includes at least one gas manifold 62, which is connected to suitable piping to tubes provided with a plurality of gas jets 64. The gas jets 64 are arranged to impinge a flame F directly on the marking surfaces 48 of all of the individual rings 22 mounted on the mandrel assembly 24. Although the illustrated embodiment includes two gas manifolds 62, it should be appreciated that a suitable system may include gas jets 64 extending from only one manifold 62. In that embodiment of the system, the gas jets 64 may be arranged to heat each adjacent ring 22, instead of every other ring 22 as with a system having two gas manifolds.

The advantage of the shielding assembly 50 is that the shields 52 and 54 prevent direct impingement by the flame F on the mandrel assembly 24. In addition, the shielding assembly 50 acts like a heat capacitor to deliver more heat from the outer perimeter marking surfaces 48 of each individual char marker ring 22 to the product P.

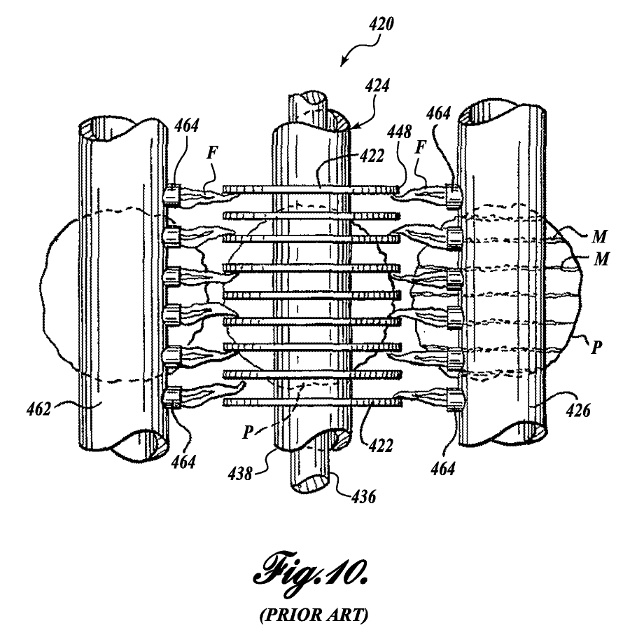

Comparatively, an illustration of a previously designed char marking assembly described in U.S. Pat. No. 4,026,201, issued to Fetzer, is shown in FIG. 10. Spacers on the char marking rings 122 shown in FIGS. 2-5 of Fetzer did not provide any heat shielding properties for the mandrel assembly 124. Therefore, this prior art design resulted in significant heat loss to the mandrel assembly 124 creating a limiting temperature for the outer perimeter marking surfaces 148 of the char marking rings 122. Because of the potential for permanent deformation or failure of components of the mandrel assembly 124, particularly the supporting shaft 136, a high temperature flame F does not directly impinge the outer perimeter marking surfaces 148 in this prior art design. Rather, to reduce damage, the flame F is typically aimed at an angle at the outer perimeter marking surfaces 148, which results in a lower maximum temperature for the outer perimeter marking surfaces 148 than would be achieved with direct flame heating. Because of this angled orientation, most of the heat produced by the flame F “blows by” the outer perimeter marking surfaces 148 and exits the system as waste heat.

Returning to FIG. 2, heat shielding improvements of the present disclosure enable higher and more predictable temperatures at the outer perimeter marking surfaces 48 of the individual char marker rings 22 than were achievable with the prior art design. In that regard, the shielding assembly 50 allows for the flame F to be aimed more directly at the outer perimeter marking surface 48 of each char marking ring 22 without overheating or damaging components of the mandrel assembly 24. This more direct aim results in higher temperatures achieved at the outer perimeter marking surfaces 48, allowing for faster throughput in the system.

Moreover, the shielding assembly 50 acts like a heat capacitor to deliver more heat from the outer perimeter marking surfaces 48 of each individual char marker ring 22 to the product P. In that regard, because of the increase in mass of the ring 22 by adding the shielding assembly 50, more heat is absorbed by the ring 22. Such heat capacity allows the outer perimeter marking surfaces 48 to be maintained at a higher temperature for a longer period of time as portions of the ring 22 rotate away from the flame F. With heat preservation on the outer perimeter marking surface 48 as the ring 22 rotates on the mandrel assembly 24, it can be assumed that a higher temperature will be achieved on the marking surface 48 than if no shielding assembly 50 was provided. Moreover, because of the increase in the overall surface area of the ring 22 by adding the shielding assembly 50, more energy from the flame F is blocked by the ring 22.

Turning now to FIGS. 7-9, char marker rings designed and configured in accordance with other aspects of the present disclosure are shown. It should be appreciated that the various embodiments shown in FIGS. 7-9 are substantially similar to the ring 22 shown in FIG. 3-6, except for differences regarding the shielding assemblies. In that regard, FIGS. 7 and 8 are directed to rings 122 and 222 having shielding assemblies 150 and 250 that surround at least a portion of the inner hole. In that regard, the shielding assemblies 150 and 250 include non-continuous shielding components, respectively, first and second shield components 152 and 154 in FIG. 7 and first and second shield components 252 and 254 in FIG. 8. FIG. 9 is directed to a ring 322 having a single shield assembly 350 on only side 342 of the ring 322.

Referring to FIG. 7, the first shield component 152 is positioned on the first side 142 of the ring 122 and surrounds at least a portion of the inner hole 146, and the second shield component 154 is positioned on the second side 144 of the ring 122 and surrounds at least a portion of the inner hole 146. Adjacent rings 122 nest together, such that the first and second shield components 152 and 154 nest together. In the illustrated embodiment of FIG. 7, the nesting shield components 152 and 154 overlap in their shielding coverage to form a substantially continuous shield. However, it should be appreciated that overlap between shield components 152 and 154 is not required. Moreover, it should be appreciated that the shield components 152 and 154 may both be positioned on the same side of the ring 122, or that rings in accordance with embodiments of the present disclosure may only include one of the first and second shield components 152 and 154 to only surround a portion of the center hole 146.

In the illustrated embodiment of FIG. 8, the shield components 252 and 254 are four components that nest together when adjacent rings 222 nest together Like the embodiment of FIG. 7, it should be appreciated that overlap between shield components 252 and 254 is not required. Moreover, it should be appreciated that the shield components 252 and 254 may both be positioned on the same side of the ring 222, or that rings in accordance with embodiments of the present disclosure may only include one of the first and second shield components 252 and 254 to only surround a portion of the center hole 246.

In the illustrated embodiment of FIG. 9, a ring 322 has a single shield assembly 350 extending from only side 342 of the ring 322. Moreover the shield assembly 350 does not include extensions and therefore interfaces directly with the second side 344 of the ring. However, it should be appreciated that extensions would be suitable for use in this embodiment.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A char marker ring, comprising:
(a) a ring body having first and second sides, an inner hole extending through the body from the first side to the second side, and an outer perimeter marking surface; and
(b) at least a first shield extending outwardly from either of the first and second sides, wherein the first shield surrounds at least a portion of the inner hole.

2. The char marker ring of claim 1, wherein the first shield substantially surrounds the inner hole.

3. The char marker ring of claim 1, wherein the first shield is a substantially continuous structure surrounding the inner hole.

4. The char marker ring of claim 1, wherein the first shield is concentric with at least one of the inner hole and the outer perimeter marking surface.

5. The char marker ring of claim 1, wherein the first shield includes an outer lip surface configured to be capable of interfacing with the other of a first or second side of an adjacent char marker ring.

6. The char marker ring of claim 1, wherein the first shield includes a plurality of extensions extending outwardly from the outer lip surface.

7. The char marker ring of claim 1, wherein the ring body is made from a metal or metal alloy.

8. The char marker ring of claim 7, wherein the first shield is made from a metal or metal alloy different from the material of the ring body.

9. The char marker ring of claim 7, wherein the first shield is made from a metal or metal alloy the same as the material of the ring body.

10. The char marker ring of claim 1, further comprising a second shield extending from the other of the first and second sides.

11. The char marker ring of claim 10, wherein the second shield surrounds at least a portion of the inner hole.

12. The char marker ring of claim 10, wherein the second shield substantially surrounds the inner hole.

13. The char marker ring of claim 1, wherein the second shield is a substantially continuous structure surrounding the inner hole.

14. The char marker ring of claim 12, wherein the second shield is sized to have a smaller diameter than the diameter of the first shield.

15. The char marker ring of claim 13, wherein the first and second shields are sized so that either of the first and second shields is capable of nesting with the other of a first and second shield of an adjacent char marker ring.

16. The char marker ring of claim 13, wherein the first and second shields substantially surround the inner hole.

17. A char marker ring assembly, comprising:
(a) a mandrel assembly; and
(b) a plurality of char marker rings received on the mandrel assembly, each of the char marker rings comprising a ring body having first and second sides, an inner hole extending though the body from the first side to the second side, and an outer perimeter marking surface, at least a first shield extending outwardly from either of the first and second sides, wherein the first shield surrounds at least a portion of the inner hole.

18. A method of using a char marker ring assembly, comprising:
(a) obtaining a char marker ring assembly comprising a plurality of char marker rings received on a mandrel assembly, each of the char marker rings having an outer perimeter marking surface;
(b) rotating the plurality of char marker rings on the mandrel assembly;
(c) heating the outer perimeter marking surfaces of each of the plurality of char marker rings with a plurality of flames; and
(d) shielding at least a portion of the direct flame heat from the mandrel assembly.

19. The method of claim 17, further comprising using the heated outer perimeter marking surfaces to brand at least one product.

20. The method of claim 17, further comprising substantially shielding direct flame heat from the mandrel assembly.
